(19) United States
(12) Patent Application Publication
(10) Pub. No.: US 2026/0033435 A1
(43) Pub. Date: Feb. 5, 2026

(54) LIGHT RESPONSE MATERIAL AND USES THEREOF

(71) Applicant: MULTI-SCALE MEDICAL ROBOTICS CENTER LIMITED, Hong Kong (CN)

(72) Inventors: Li Zhang, Hong Kong (CN); Xin Wang, Hong Kong (CN)

(21) Appl. No.: 19/288,466

(22) Filed: Aug. 1, 2025

Related U.S. Application Data
(60) Provisional application No. 63/678,660, filed on Aug. 2, 2024.

(51) Int. Cl. A01G 7/00; C08F 220/06; C08F 220/56; C08F 222/38; C08K 3/04

(52) U.S. Cl. CPC A01G 7/00; C08F 220/06; C08F 220/56; C08F 222/385; C08K 3/042; C08F 2810/20

(57) ABSTRACT

This invention provides a light response material. In one embodiment, said light response material comprises: a) a hydrogel of sufficient fracture toughness to accumulate elastic energy for actuation prior to fracture; and b) a photothermal material dispersed in said hydrogel capable of initiating phase transition of water inside said hydrogel from liquid to vapor when irradiated with light to cause accumulation of said elastic energy.

### FIELD OF THE INVENTION

The present invention generally relates to an actuation material, particularly, light response material.

### BACKGROUND OF THE INVENTION

This invention relates to an engineered accumulated strain energy-fracture (ASEF) power-amplification method that utilizes an explosive fluid vibration triggered by the photothermal response of graphene embedded within a copolymer hydrogel.

Small-scale robotic systems for applications in medicine, micromanipulation, and environmental remediation require energy input and conversion that are capable of robust shape change or propulsion. For robotic tasks that require jumping, ejection, or catapulting, such devices typically need the energy release over short time durations (i.e. short energy releasing time) to produce a sufficient driving force. This is usually accomplished with power-amplification strategies in which an appreciable amount of kinetic energy is generated from a pre-stored energy (e.g., elastic energy or chemical energy in fuel). Examples include natural and engineered actuation systems based on latch-medicated spring structure, accumulated strain energy-fracture (ASEF) mechanism, and buckling instability, which accumulate elastic potential energy in the elastic component and convert this stored energy to kinetic energy when triggered. Tremendous progress has been made in recent years to adopt power-amplification strategies of latch-spring system and buckling instability to design engineered miniature robotic devices to achieve fast motions (e.g., jumping, launching, catapult). These include a millimeter-scale magnetic gear (latch)-mediated spring system, magnetic phase-change soft actuators, and stimuli responsive snap-through based miniature actuators trigged by light, solvent, magnetic field or electrical field. However, miniature latch-spring systems require sophisticated fabrication processes to integrate multiple components (i.e. spring, latch and motor). As with engineered systems that use buckling instability, such latch-spring approaches fall short of the performance of natural systems due to limitations on pre-stored energy. Therefore, it remains necessary to develop a new power-amplification mechanism to push the limits of engineered miniature scale devices in order to match or even surpass the remarkable performance achieved by natural systems in terms of take-off velocity and acceleration.

### SUMMARY OF THE INVENTION

This invention provides a light response material. In one embodiment, said light response material comprises: a) a hydrogel of sufficient fracture toughness to accumulate clastic energy for actuation prior to fracture; and b) a photothermal material dispersed in said hydrogel capable of initiating phase transition of water inside said hydrogel from liquid to vapor when irradiated with light to cause accumulation of said clastic energy.

This invention also provides a launcher comprising the light response material of this invention.

This invention further provides a robot comprising the light response material of this invention.

This invention further provides a system. In one embodiment, said system comprises: a) the robot of this invention; b) a light source for initiating actuation of said robot; and c) a RFID reader for reading said information from the RFID tag.

This invention further provides a method to fabricate the light response material of this invention. In one embodiment, said method comprises the steps of: a) providing a solution comprising a precursor of said hydrogel and said photothermal material; and b) irradiating said solution with UV light.

### BRIEF DESCRIPTION OF THE FIGURES

FIGS. 1A to 1F shows the accumulated strain energy-fracture (ASEF) based power-amplification (FIG. 1A) Photographs and (FIG. 1B) the mechanism of seed dispersal of squirting cucumber. (FIG. 1C) Schematic illustration of the fracture driven power amplification mechanism and high-speed camera images obtained from Supplementary Video 1 showing take-off moment from a glass substrate. (FIG. 1D) An overlaid image indicating the self-launching height of G-hydrogel launcher under irradiation of NIR light. (FIG. 1E) Ashby plot of take-off acceleration and take-off velocity for the comparison of the G-hydrogel launcher with ASEF based seed dispersal of plants. (FIG. 1F) Ashby plot of take-off acceleration and power output for the comparison of the G-hydrogel launcher with launching motion of animals and engineered launcher (find details of comparison in Supplementary Table 1).

FIGS. 2A to 2F show the factors influencing the driving force for G-hydrogel launchers. Driving force of self-launching motion behavior for G-hydrogel launchers with different (FIG. 2A) graphene content and (FIG. 2B) water content. The bottom inset shows the toughness and the top inset shows the trade-off relationship of ultimate strength and fracture strain of the G-hydrogel with different water content. Data points are shown as mean±s.d. (n=7). (FIG. 2C) The stress-strain curves of G-hydrogel with different water content. The tested strain rate and temperature is 0.05 s⁻¹ and 15° C., respectively. (FIG. 2D) The driving force for self-launching with different light intensities. Data points are shown as mean±s.d. (n=7). (FIG. 2E) The driving force and take-off velocity with different hydrogel (FIG. 2E) diameter and (FIG. 2F) thickness. Data points are shown as mean±s.d. (n=7). Note that the forces shown in FIGS. 2A to 2F are calculated based on Supplementary Note 4.

FIGS. 3A to 3K shows the structure design and launching trajectory control of hydrogel robot. (FIG. 3A) Schematic illustration showing the design principle of the light driven launching hydrogel robot. (FIG. 3B) Overlaid images showing left launch and right launch motions. (FIG. 3C) Statistics of landing locations of hydrogel robots with (FIG. 3C) two, (FIG. 3D) three and (FIG. 3E) four controllable launching direction. Inset: images of the hydrogel robot. (FIG. 3F) Schematic illustration showing the design principle of the trajectory prediction. (FIG. 3G) Simulated (dash line) and experimentally recorded launching trajectories of a jumping hydrogel robot. (FIG. 3H) The overlaid images indicating the hydrogel robot reaches a specified area based on computational simulation. (FIG. 3I) Schematic illustration and (FIG. 3J) overlaid images showing the design principle of self-launching and catapult motion for the G-hydrogel robot. (FIG. 3K) The structure design principle to control the fracture direction.

FIGS. 4A to 4L show Ecballium-inspired seed dispersal and smart seed robot. (FIG. 4A) Schematic illustration of the structural design of an artificial Ecballium elaterium. Inset: Seed dispersal of natural Ecballium elaterium. (FIG. 4B) Location of seed landing points (total 15 seeds), the inset is average launching ratio. Data points are shown as mean±s.d. (n=5). (FIGS. 4C to 4E) Overlaid images of bio-mimic seed dispersal behavior. Inset: the average launch ratio of 5 launching experiments. (FIGS. 4F and 4G) Schematic and image of the smart seeding robot, diagram of the setup and (FIG. 4H) schematic illustration of the logic process of the experimental setup. (FIGS. 4I to 4L) Photographic sequence of the experiment.

FIG. 5 is a schematic illustration of the fabrication process of the hydrogel launcher.

FIGS. 6A to 6D are the characterization of the hydrogel launcher. (FIG. 6A) The image of the representative hydrogel launcher. (FIG. 6B) SEM image indicating the surface morphology and (FIG. 6C) structure of the hydrogel launcher. (FIG. 6D) The FTIR spectra of the hydrogel launcher.

FIG. 7 shows temperature change during the NIR light activating period.

FIG. 8 shows stress-strain curve of a representative hydrogel stripe that containing 70% water indicating the toughness of the material.

FIGS. 9A and 9B show the SEM images of fractured zone and unprocessed region respectively.

FIG. 10 shows the high-speed images showing the phase transition process in the silicon oil of the hydrogel launcher.

FIG. 11 shows the high-speed camera images obtained from Supplementary Video 1 showing take-off process from a glass substrate.

FIG. 12 shows the high-speed images showing unsuccessful launching motion in the high-adhesion force condition.

FIG. 13 is the Ashby-style plot of take-off velocity and energy releasing time for the comparison of the G-hydrogel launcher with launching motion of plants, animals and artificial catapult.

FIG. 14 shows weight different of the hydrogel launcher before and after the light driven launching motion.

FIG. 15A shows the measured force output of the G-hydrogel launcher from three actuation tests. Note that the acquisition rate is 33.3 kHz of the sensor. FIG. 15B shows the Zoom in image of the red area of the red curve in FIG. 15A.

FIGS. 16A to 16G show self-launching behavior of the hydrogel launcher from different terrain surface of (FIG. 16A) plants leaves, (FIG. 16B) soft sand, (FIG. 16C) glycerol solution (FIG. 16D) grass, (FIG. 16E) branches and bark, (FIG. 16F) fine powder and (FIG. 16G) inside the sand.

FIG. 17 is the overlaid image showing the sunlight driven self-launching behavior of hydrogel launcher.

FIG. 18 shows the comparison of the (left) proposed ASEF-based mechanism and (right) the mechanism for launching fireworks (i.e. use propellant to produce high-temperature gas).

FIGS. 19A to 19C show the surface temperature change of G-hydrogel launchers with different graphene content under the irradiation of NIR light. (FIG. 19A) Schematic illustration of the test platform. The infrared thermal camera used to monitor the temperature changes. (FIG. 19B) The surface temperature change of launchers with different graphene content. Note that the light intensity and distance between light source and launcher are 20 W/cm² and 2 cm, respectively. (FIG. 19C) The representative infrared thermal images (graphene content is 0.13 wt %) obtained from the recorded video.

FIG. 20A shows the experimental setup of NIR light penetration depth test. FIG. 20B shows the detected light intensity for G-hydrogel samples with different thickness. (Note that the light intensity is 13 W/cm²)

FIG. 21A shows the experimental setup of the cross-section temperature test. FIG. 21B shows the image sequence illustrated the temperature change of the cross section of the sample (the thickness of the sample and light intensity is 5 mm and 15 W/cm2, respectively). FIG. 21C is a schematic illustration of the light blocking effect of the graphene and temperature gradient (red color).

FIG. 22A shows the representative measured force output of the G-hydrogel launcher with different graphene content. Note that the acquisition rate is 33.3 kHz of the sensor, and the diameter and water content of the hydrogel launcher are 10 mm and 70 wt %. FIG. 22B shows the comparison of the experimental measured force with the calculated force that through recording the launching height. Data points are shown as mean±s.d. (n=3).

FIG. 23 shows the Young's modulus of the hydrogel with different graphene content. Note that the water content is 70 wt %. Data points are shown as mean±s.d. (n=3).

FIG. 24 shows the stress-strain curves of the hydrogel with different water losing ratio (i.e. 0%, 20%, 40%, 60%). Inset: Photograph of the hydrogel samples with different water losing ratio.

FIGS. 25A and 25B show the stress-strain curves and the comparison of ultimate stress and stain for G-hydrogel under different strain rate respectively. Note that the test is carried in room temperature. Data points are shown as mean±s.d. (n=3).

FIGS. 26A and 26B show the influence of the temperature on stress-strain curve. (FIG. 26A) The IR image was taken during the test illustration the measurement platform. (FIGS. 26B) The stress-strain curves of the G-hydrogel under different temperature. (Note that the strain rate is 0.05 s-1)

FIG. 27 shows the temperature change during the launching process under the irradiation of different NIR light intensity.

FIG. 28 shows the simulated displacement of the G-hydrogel with different diameter. Note that the diameter in the simulation is set as 5 mm, 6 mm, 7 mm and 8 mm, respectively.

FIG. 29 shows the simulated displacement of the G-hydrogel with different thickness. Note that the thickness in the simulation is set as 2 mm, 3 mm, 4 mm and 5 mm, respectively.

FIG. 30 shows the simulated (dash line) and recorded experimental launching trajectories of the designed hydrogel robot.

FIGS. 31A and 31B show the overlaid images of launched hydrogel robot and the trajectory analysis actuated by NIR light with intensity of 15 W/cm², 20 W/cm² and 25 W/cm², respectively.

FIGS. 32A and 32B show the schematic illustration and corresponding overlaid images showing launched hydrogel robot through the holes with different height.

FIG. 33A is a schematic illustration showing the combination and launching process of the 3D printed rocket. FIG. 33B is the overlaid image and FIG. 33C is the enlarged overlaid image indicating the launching height of the G-hydrogel launcher driven rocket. FIG. 33D shows the mass of total and hydrogel launcher and FIG. 33E shows the comparison showing the powerful driven force based on ASEF mechanism. Data points are shown as mean±s.d. (n=8).

FIG. 34A is a schematic illustration showing the structure of the light-driven hydrogel catapult. FIG. 34B is a series snapshots of launching process and FIG. 34C shows the corresponding motion behavior of the G-hydrogel launcher. FIG. 34D shows the trajectory of the launched cargo. Inset: the angle of the G-hydrogel launcher relative to the initial position.

FIGS. 35A to 35E show the Ecballium-inspired seed dispersal. (FIG. 35A) The sprout results of experimental group (seeds experienced the high-temperature vapor ejection) and (FIG. 35B) control group that both contained 5 Impatiens balsamina seeds. (FIG. 35C) Schematic illustration of the structural design of an artificial Ecballium elaterium with thermal insulation panel. (FIG. 35D) The image of hydrogel launcher with thermal insulation panel. (FIG. 35E) Photographic sequence of the seed dispersal process.

FIGS. 36A to 36C are the schematic illustration of the structure of the smart seed hydrogel robot the water absorption ability of the hydrogel.

### DETAILED DESCRIPTION OF THE INVENTION

This invention provides an engineered accumulated strain energy-fracture (ASEF) power-amplification method that utilizes an explosive fluid vibration triggered by the photothermal response of graphene embedded within a copolymer hydrogel.

The foregoing and other aspects and advantages of the invention will appear from the following description. In the description, reference is made to the accompanying drawings that form a part hereof, and in which there is shown by way of illustration a preferred embodiment of the invention. Such embodiment does not necessarily represent the full scope of the invention, however, and reference is therefore made to the claims and herein for interpreting the scope of the invention.

This invention provides a light response material. In one embodiment, said light response material comprises: a) a hydrogel of sufficient fracture toughness to accumulate elastic energy for actuation prior to fracture; and b) a photothermal material dispersed in said hydrogel capable of initiating phase transition of water inside said hydrogel from liquid to vapor when irradiated with light to cause accumulation of said elastic energy.

In one embodiment, said hydrogel is a copolymer hydrogel.

In one embodiment, said copolymer hydrogel is covalently cross-linked.

In one embodiment, said copolymer hydrogel comprises two or more polymers selected from the group consisting of acrylic acid (AA), Acrylamide (AAm), Sodium Acrylate, and Vinylpyrrolidone (VP).

In one embodiment, said photothermal material comprises one or more selected from the group consisting of graphene, carbon nanotubes (CNTs), polypyrrole nanoparticle, and Fe₃O₄ nano particles.

In one embodiment, said photothermal material is present in an amount of 0.05 wt % to 0.43 wt %.

In one embodiment, said hydrogel has a water content of 55 wt % to 80 wt %.

In one embodiment, said light comprises NIR laser.

This invention also provides a launcher comprising the light response material of this invention.

In one embodiment, said light response material has a thickness of 3 to 6 mm.

In one embodiment, said light response material has a diameter of 3 to 15 mm.

This invention further provides a robot comprising the light response material of this invention.

In one embodiment, said robot comprises two or more of said light response material being embedded in a block to be actuated.

In one embodiment, said robot comprises a layer of said light response material attached to a layer of constrain material.

In one embodiment, said robot further comprises a RFID tag containing information to be read out by a RFID reader.

This invention further provides a system. In one embodiment, said system comprises: a) the robot of this invention; b) a light source for initiating actuation of said robot; and c) a RFID reader for reading said information from the RFID tag.

In one embodiment, said system further comprises a communication module for conveying said information to other components.

This invention further provides a method to fabricate the light response material of this invention. In one embodiment, said method comprises the steps of: a) providing a solution comprising a precursor of said hydrogel and said photothermal material; and b) irradiating said solution with UV light.

In one embodiment, said hydrogel is a copolymer hydrogel comprising two or more polymers selected from the group consisting of acrylic acid (AA), Acrylamide (AAm), Sodium Acrylate, and Vinylpyrrolidone (VP).

In one embodiment, said photothermal material comprises one or more selected from the group consisting of graphene, carbon nanotubes (CNTs), polypyrrole nanoparticle, and Fe₃O₄ nano particles.

Embodiments of the present invention relate to the power amplification mechanism, materials, fabrication of the hydrogel launcher, and devices. The launcher consists of the copolymerized hydrogel doped with graphene. The fracture driven power amplification strategy harnesses the fast liquid vaporization triggered by the photothermal response of an embedded graphene suspension. This vaporization leads to appreciable elastic energy stored within the surrounding hydrogel network, followed by rapid clastic energy within ultrashort time period. Furthermore, the present invention relates to all the materials, systems and devices that are designed for the demonstration of the fracture driven power amplification strategy.

In one embodiment, the present invention provides a fracture driven power amplification strategy for the actuation of the miniature soft robot, which harnesses the fast liquid vaporization of the hydrogel triggered by the photothermal response of an embedded materials with photothermal effect. Among others, the hydrogel material should have a characteristics combination of high toughness, elasticity, include but not constraint of Poly (N-vinyl-2-pyrrolidone-co-acrylic acid) hydrogels (P (VP-co-AA) hydrogels), Poly (acrylic acid-co-acrylamide) hydrogels (P (AM-co-AA) hydrogels), sodium polyacrylate hydrogels (PAANa hydrogels) system. Furthermore, the materials with significant photo-thermal effect can be selected as alternatives to achieve the reported power amplification mechanism, such as 2D materials (e.g. CNTs, graphene), Fe₃O₄ nano particles and even the green water-soluble dye. Embodiments of the present power amplification method may include the launcher fabricated by P(AM-co-AA) hydrogel doped with graphene that actuated by NIR light.

In one embodiment, the hydrogel launcher obtained based on the layer by layer free-radical polymerization method. The hydrogel launcher can be designed to achieve two different actuation modes (i.e. self-launching and catapult motion) by tailoring the structural composition and geometry to control the location and direction of the propulsion. A two-layered structure in which a hydrogel doped with graphene layer and a pristine hydrogel layer are stacked together to control the direction of propulsion. The downward and upward jetting of water vapor can be realized, and thus achieve the self-launching and catapult actuation modes, respectively.

In one embodiment, the present invention relates to a soft robot device capable of motion with directional jumping motion. In one embodiment, the two hydrogel launchers are embedded in a pristine rectangle shape hydrogel block, this results in a soft hydrogel robot that can launch in two different directions depending on which launcher is stimulated. In addition, in embodiment, the hydrogel robot device can be designed with multi directional (e.g. three and four directions) jumping ability through asymmetric structural design, i.e. there or four hydrogel launchers embedded in pristine hydrogel block with there or four foots, respectively.

In one embodiment, the present invention relates to an engineered version seeding robot of the Ecballium elaterium to mimic the process of seed dispersal, the hydrogel launcher was fabricated and assembled inside a 3D printed semi-transparent resin shell, which was placed on the branch of a plant. Fifteen black glass beads were inserted on the top of the hydrogel launcher to mimic seeds. This artificial Ecballium elaterium ejected the glass beads at high speeds through NIR stimulation.

In one embodiment, the present invention relates to a smart seed robot for automatically planting seeds within a soil. The smart seed robot consists of the RFID card and hydrogel launcher for actuation. The related devices of the smart bed contain an RFID reader, a cultivation soil bed, an automatic soil feeder, an automatic water supplier, and a humidifier. The smart seeding process can be realized through the automated control.

### EXAMPLE 1

### Fabrication of the launchers

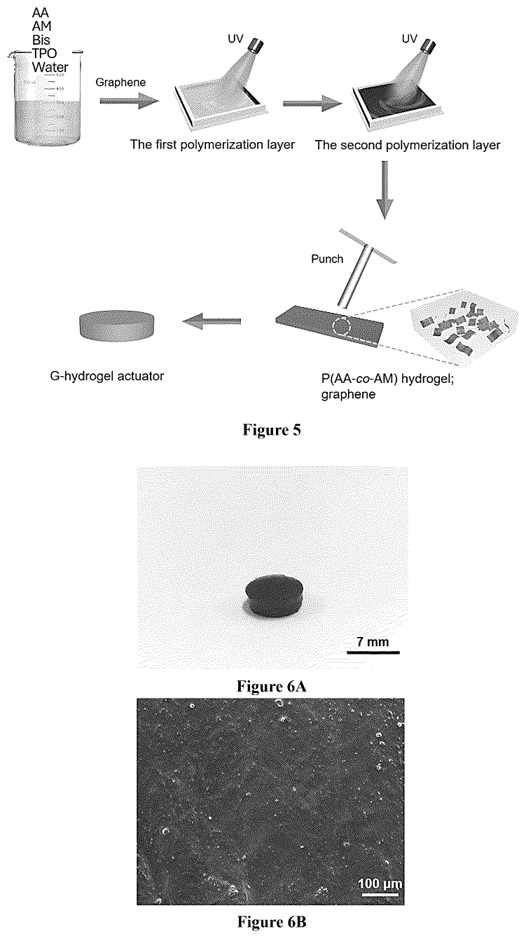

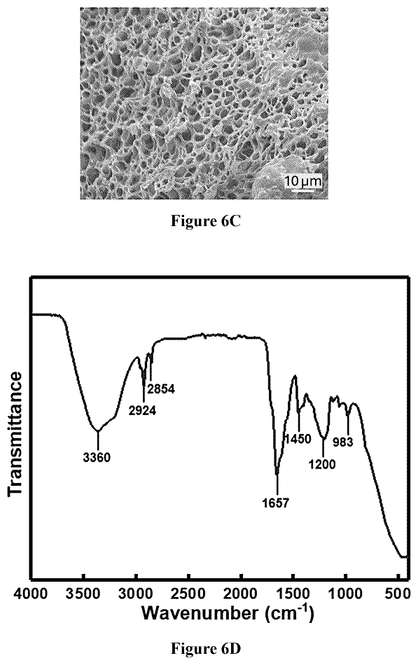

As shown in FIG. 5, the hydrogel launcher is fabricated based on the layer by layer free-radical polymerization method, in an embodiment, the hydrogel precursor contained Acrylamide (AM), acrylic acid (AA), N,N′-methylenebisacrylamide (MBA), 2,4,6-trimethylbenzoyl-diphenylphosphine oxide (TPO), graphene and water was polymerized by irradiated with UV light for 2 mins, the film with different thickness can be obtained by multiple layer polymerization. Finally, the hydrogel launcher successfully fabricated through a punch cutting. In embodiments, as shown in FIGS. 6A to 6D, the representative hydrogel launcher has a simple cylindrical shape with the diameter and thickness are 7 mm and 3 mm, respectively. As can be seen from the scanning electron microscopy (SEM) images in FIGS. 6B and 6C that the launcher has a smooth surface and the graphene uniformly distribute throughout the whole crosslinked hydrogel network. In addition, as shown in Fourier transform infrared (FTIR) spectrum of the P (AA-co-AM) hydrogel with graphene (FIG. 6D), the broad bond from 3660 cm⁻¹ to 3000 cm⁻¹ is attributed to the O—H and N—H bonds, the characteristic peaks at 1657 cm⁻¹ and 1450 cm⁻¹ are corresponded to the stretching absorption of C═O in polyacrylic acid and polyamide, respectively, which confirmed the presence of P (AA-co-AM) copolymer. In the current embodiment, the fracture driven power amplification method are demonstrated in the above mentioned hydrogel launcher.

This invention provides an engineered accumulated strain energy-fracture (ASEF) power-amplification method that utilizes an explosive fluid vibration triggered by the photothermal response of graphene embedded within a copolymer hydrogel.

### Accumulated Strain Energy-Fracture (ASEF) Power-Amplification Mechanism

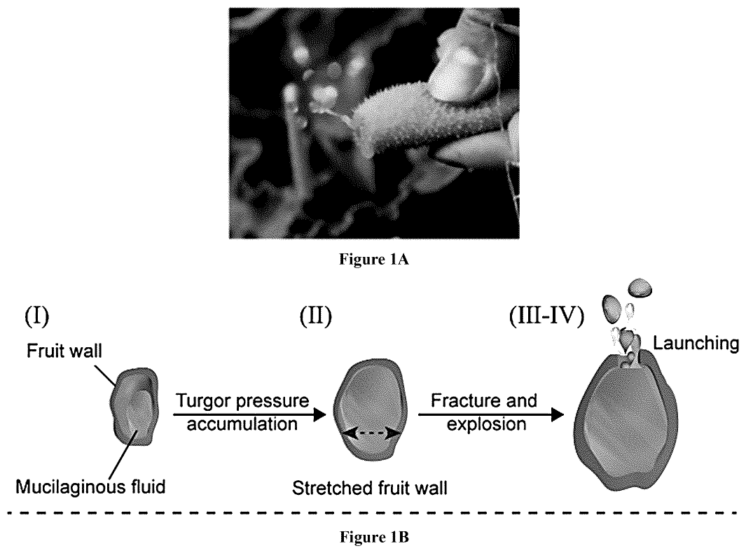

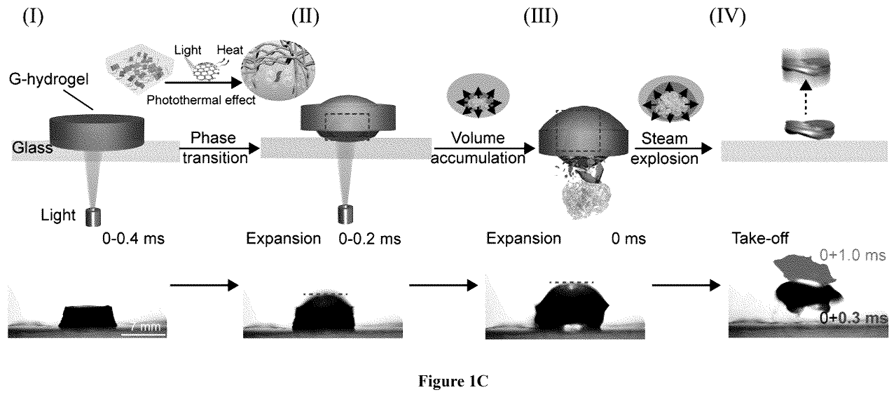

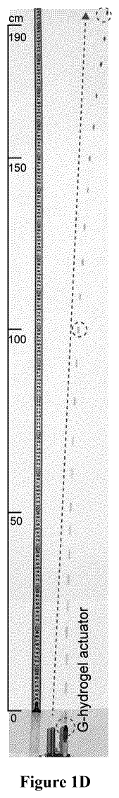

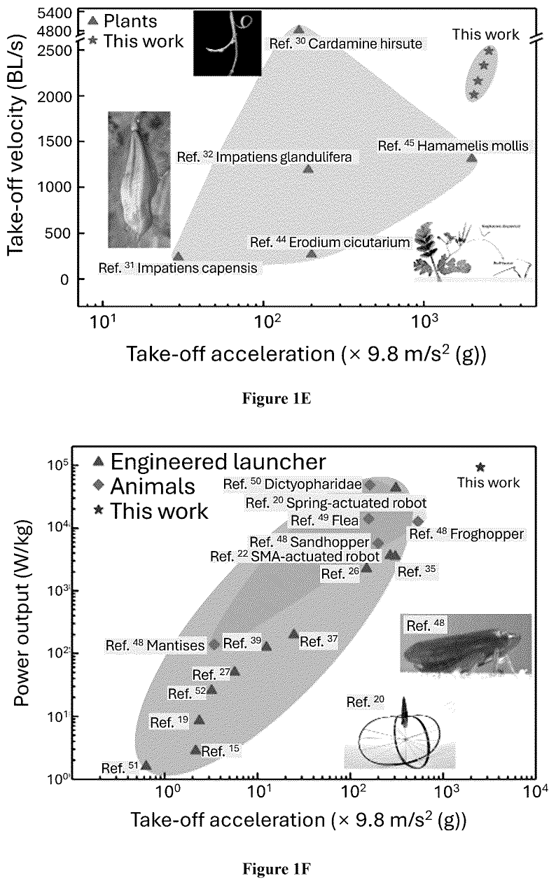

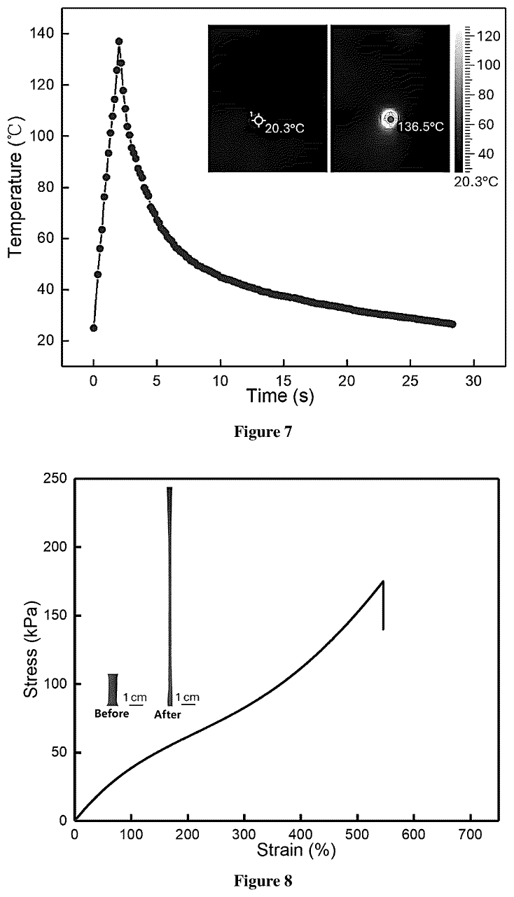

Ballistic dispersal is a unique method in plants and involves ejection of seeds over long distances through explosive dehiscence of the fruit. For example, during the growth of a squirting cucumber (FIG. 1A), the pulp will transform into a mucilaginous liquid mass and the fruit wall will be stretched (strain energy accumulation) (FIG. 1B-II). The fracture occurs (energy release) when a critical pressure is reached and enables the launching of seeds with high velocity and acceleration (FIG. 1B-III). Inspired by this power-amplification method, an engineered version ASEF power-amplification method was developed and demonstrate it through a soft hydrogel launcher, that is composed of graphene embedded in a copolymer hydrogel (referred as G-hydrogel) (FIG. 1C). The ASEF power-amplification is enabled by the photothermal response of the embedded graphene sheets (Supplementary Note 1) under high-energy light irradiation (20 W/cm² near-infrared (NIR) light). The light stimulation causes the composite to rapidly heat within the irradiated zone due to the photothermal effect (heating from 20.3° C. to 136.5° C. within 2 seconds, FIG. 7). This, in turn, induces a phase transition of water within the hydrogel from liquid to vapor (FIG. 1C). The actuation process is illustrated in FIG. 1C and its corresponding snapshots at critical stages are recorded by a high-speed camera (FIG. 1C and Supplementary Video 1). The continuous light irradiation induces vaporization of water, resulting in the rapid and continuous expansion of the hydrogel matrix due to the accumulated vapor pressure (FIG. 1C-II and III), which is correspond to the deformation of fruit wall during the growth of squirting cucumber (FIG. 1B-II and III). The deformation of the G-hydrogel (w) within the hydrogel before fracture (i.e. fracture in FIG. 1C-III) can be calculated through following equation based on an elastic plate theory:

$${∇}^{4} w = - \frac{q}{D} \qquad ( 1 )$$

where w is the relative longitudinal deformation displacement, q is the load intensity, the factor D is the flexural rigidity, and ∇² is the Laplacian operator that is defined for cylindrical coordinates r and q. The stored clastic energy in deformed G-hydrogel due to this pressured water vapor can be calculated as:

$${U}_{total} = {U}_{s} + {U}_{b} = \frac{32 π}{3} \frac{{w}_{0}^{2}}{{r}_{0}^{2}} D + \frac{π E h}{1 - {v}^{2}} {\int }_{0}^{a} ( {ε}_{r}^{2} + {ε}_{t}^{2} + 2 v {ε}_{r} {ε}_{t} ) r d r \qquad ( 2 )$$

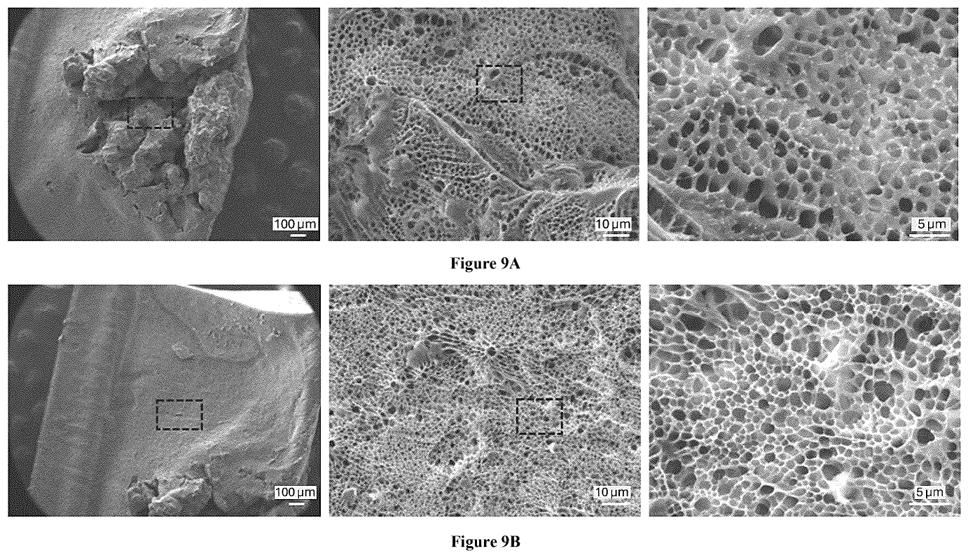

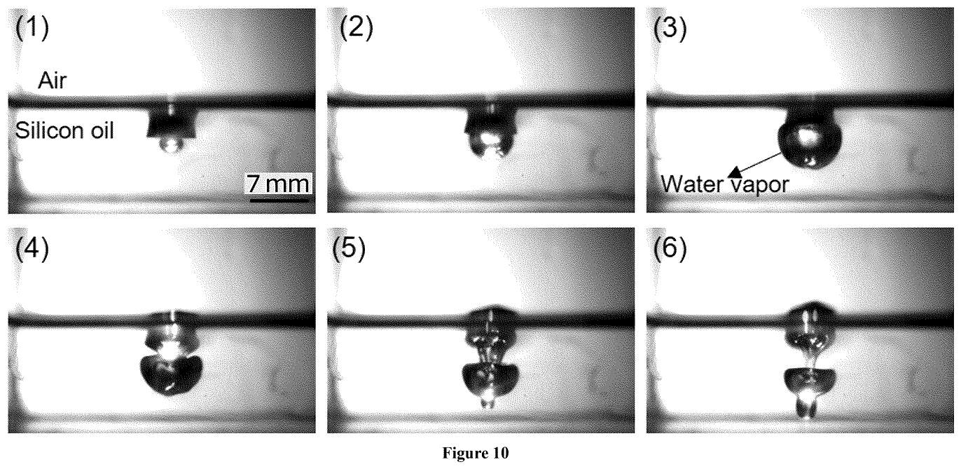

Here Uₛ and U_{b} are the strain energy caused by stretching and bending, respectively, v is the Poisson's ratio of the G-hydrogel, E is the Young's module and εᵣ and εₜ are the strain components (see details of derivation in Supplementary Note 2). The use of a copolymerized hydrogel matrix poly (acrylic acid-co-acrylamide) (P (AA-co-AM)) with high stretchability and toughness (FIG. 8) allows for large deformation of the launcher (FIG. 1C-III), i.e., storage of appreciable elastic energy prior to energy release. As with the G-hydrogel presented in FIG. 1C, the maximum stored elastic energy is estimated to be in the range of 3.60 mJ to 5.66 mJ. It should be noted that the kinetic contribution of fracture induced water steam jet was neglected (FIGS. 9A and 9B) due to the relatively small energy (4.17×10⁻³ mJ) (sec details in Supplementary Note 2).

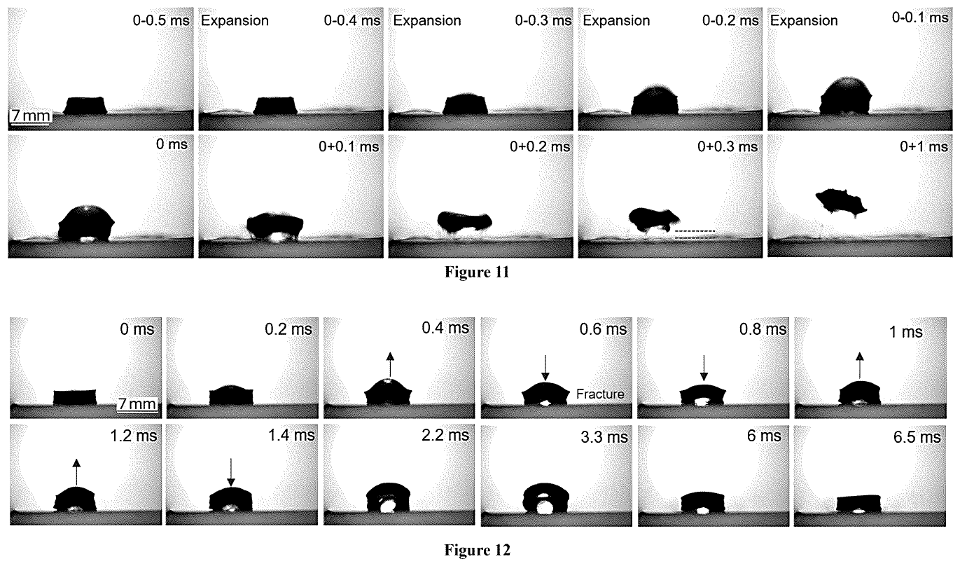

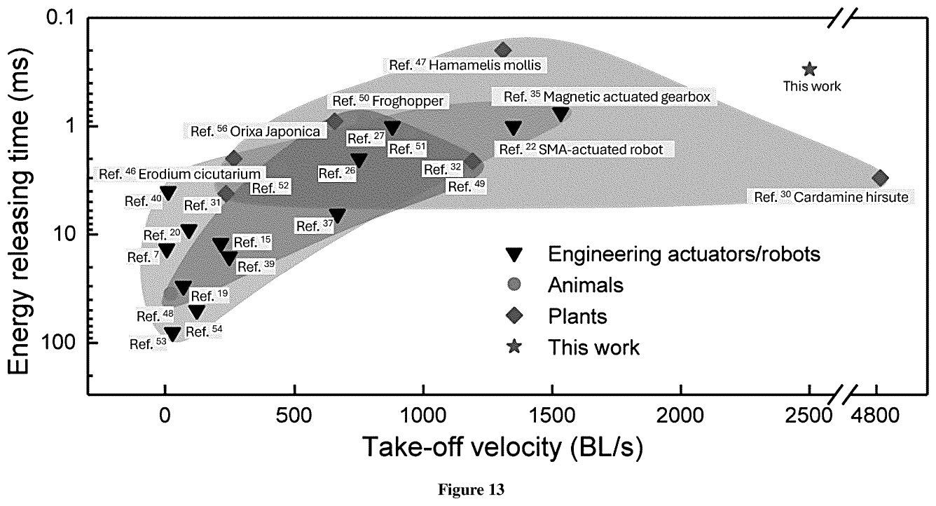

The high-speed pressure released by vapor ejection (Supplementary Video 2 and FIG. 10) leads to the release of stored elastic energy over a short time duration of 0.3 ms, which can be defined as the take-off time (i.e. from the fracture occurred until the G-hydrogel launcher completely detached with the surface of the substrate), as shown in FIG. 1C-III-IV and FIG. 11. The vapor ejection visualized by actuating the hydrogel launcher in the silicon oil as shown in FIG. 10. This rapid response endows the G-hydrogel launcher with exceptional performance in terms of take-off acceleration and velocity (exhibited as the high launching height). FIG. 1D shows a representative G-hydrogel launcher performing a vertical launching motion over 193 cm—i.e. 643 body lengths (BL) of the cylindrical launcher with a thickness of 3 mm and diameter of 7 mm (Supplementary Video 3). Note that for best performance, it is necessary to minimize adhesion to the substrate (FIG. 12). The take-off velocity (v_{take-off}) was calculated by considering the post-take-off motion of G-hydrogel launcher until reaching the maximum launching height as a deceleration motion driven by the gravity and the air drag force based on the following equation:

$${v}_{take - off} = \sqrt{\frac{\vert {e}^{\frac{h {e}_{d} ρ A}{m}} - 1 \vert \times 2 m g}{{C}_{d} ρ A}}$$

where m is the mass of hydrogel launcher (115 mg) and g is the gravitational acceleration. C_{d} is the drag coefficient (0.97). A is the cross-section area that can be calculated form A=πr₀²=38.47 mm². For the G-hydrogel launcher shown in FIG. 1D, the theoretical take-off velocity can be calculated as 7.50 m/s, which shows limited error with the take-off speed measured from the high-speed camera launching tests (find calculation details in Supplementary Note 3). The recorded high-speed camera video (FIG. 1C-III-IV) also reveals the extremely short take-off duration (0.3 ms), indicating the high take-off acceleration of 2.5×10⁴ m/s² (>2500 g). It reveals that this ASEF based power-amplification mechanism endows the remarkable performance of the proposed G-hydrogel launchers compared to other jumping/launching based systems as the Ashby-style plots shows in FIGS. 1E and IF and FIG. 13, respectively.

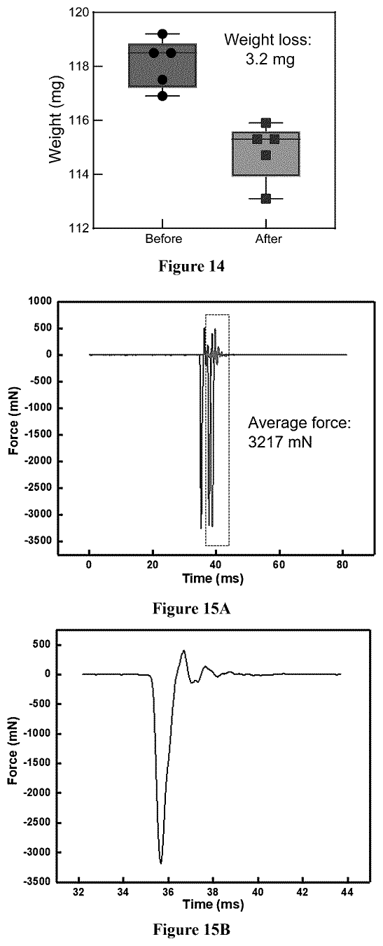

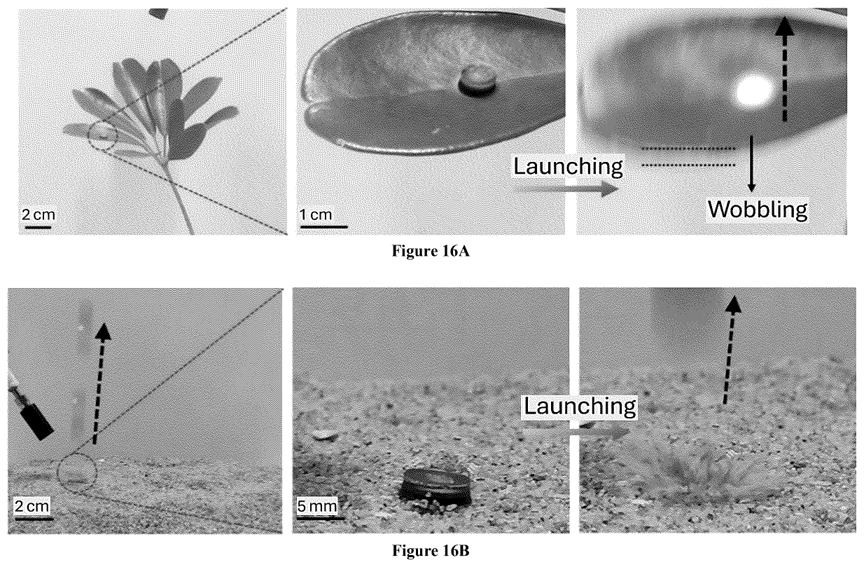

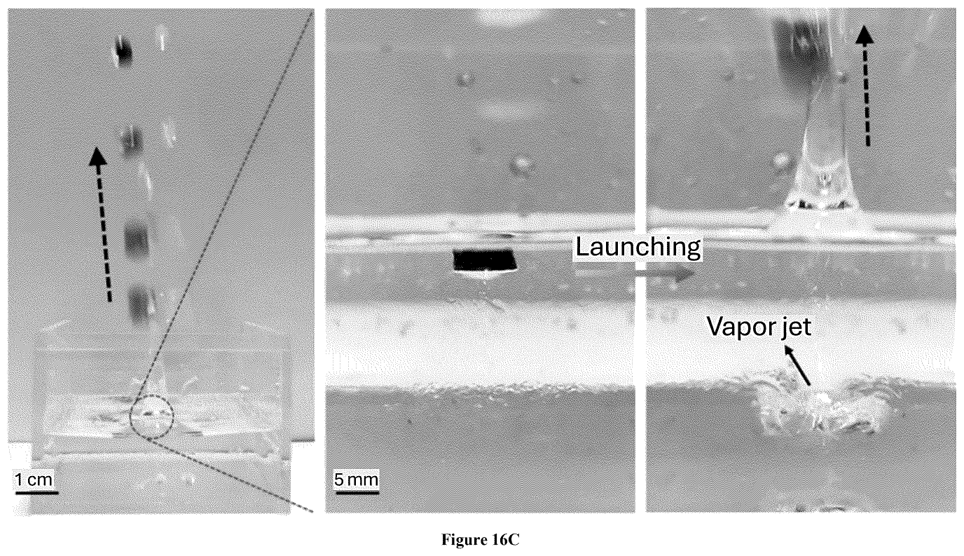

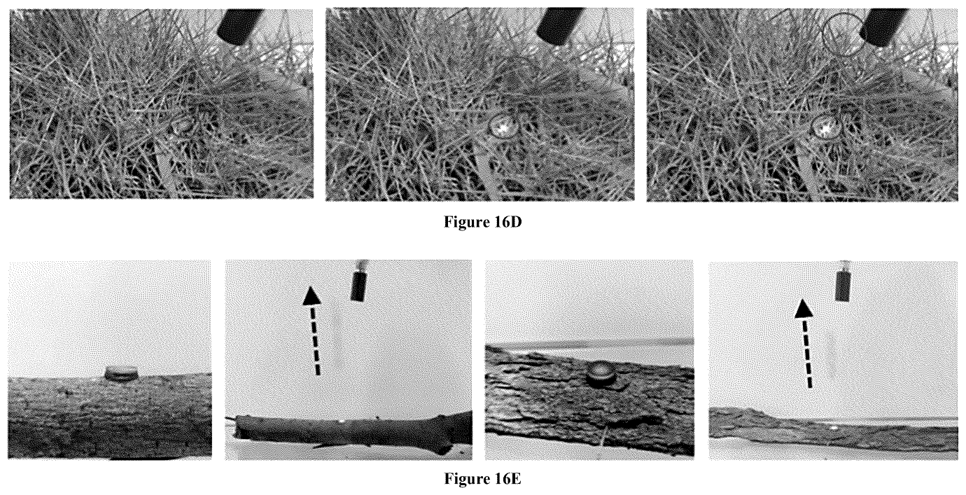

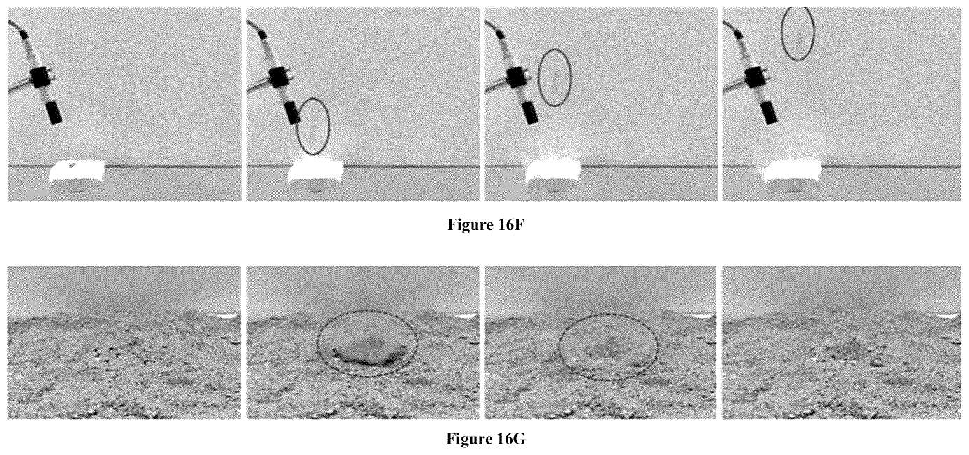

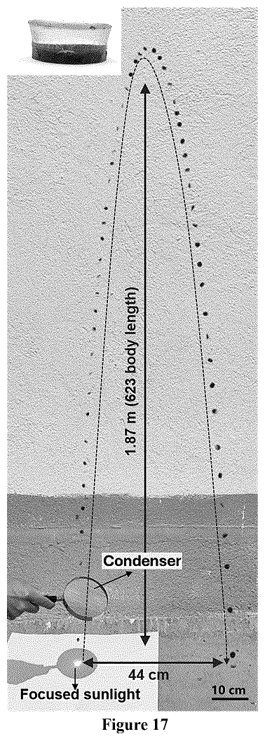

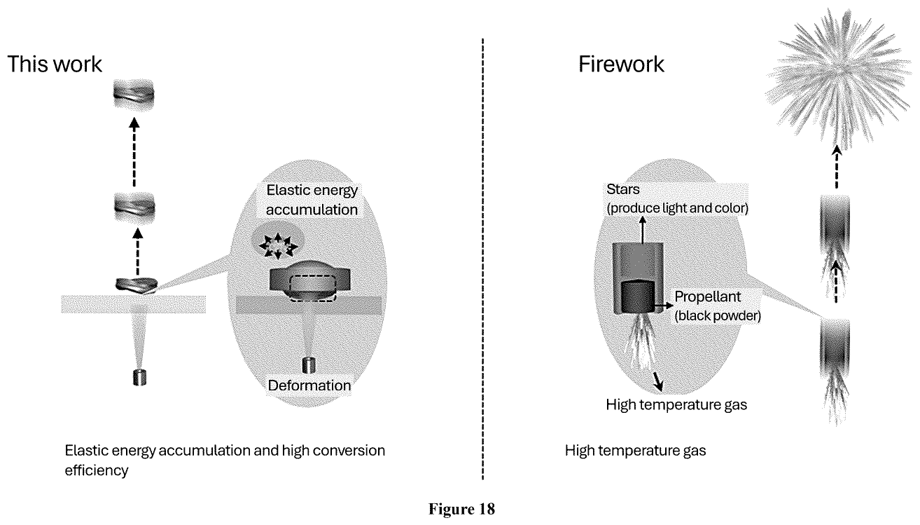

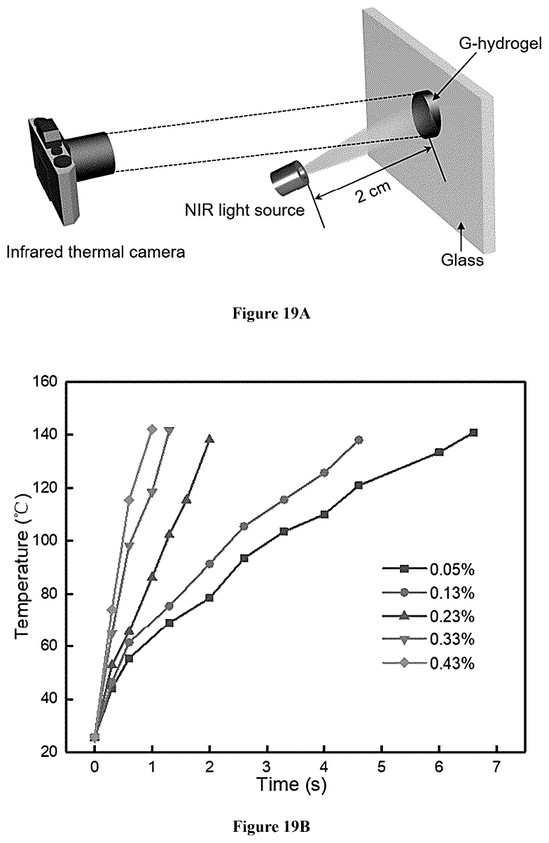

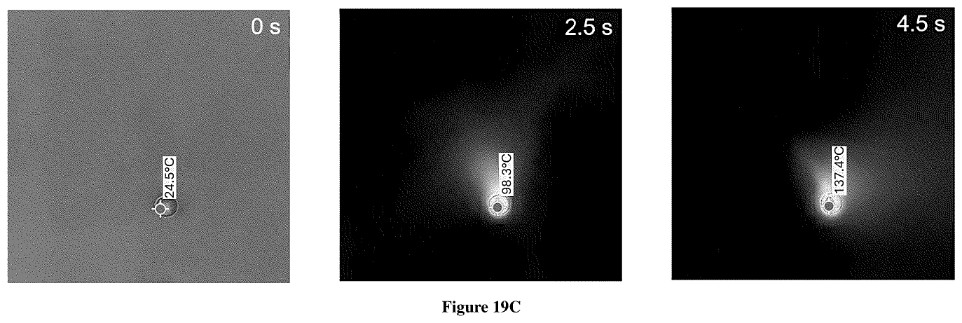

The substantial amount of stored elastic energy and fast release rate corresponds to a calculated launching force F_{launching}=mv_{take-off}/t+mg=2876 mN that greatly exceeds the gravitational weight of the launcher (1.13 mN for 115 mg launcher excluding ˜ 3.2 mg weight loss during actuation, as shown in FIG. 14). The force output (˜3217 mN shown in FIGS. 15A and 15B) during actuation was also measured through launching on the force sensor. The result shows limited errors with calculations (i.e. 2876 mN). The fast and substantial elastic energy release also enables the self-launching motion of hydrogel launcher on different terrains, including wobbly plant leaf, granular surface, viscous liquid surface, and other nature terrains i.e. excellent environment adaptability as shown in FIGS. 16A to 16G (FIGS. 16A to 16G and Supplementary Video 4). Focused sunlight to activate the G-hydrogel launcher (launching height: 187 cm/623 body length) was also demonstrated, suggesting the potential for natural light as a power source (FIG. 17 and Supplementary Video 5). It should be noted that the ASEF propulsion mechanism demonstrated here is distinct from the mechanism for launching fireworks, which relies on combustion with a propellant to produce high-temperature gas (FIG. 18).

### Characterization of Actuation Performance

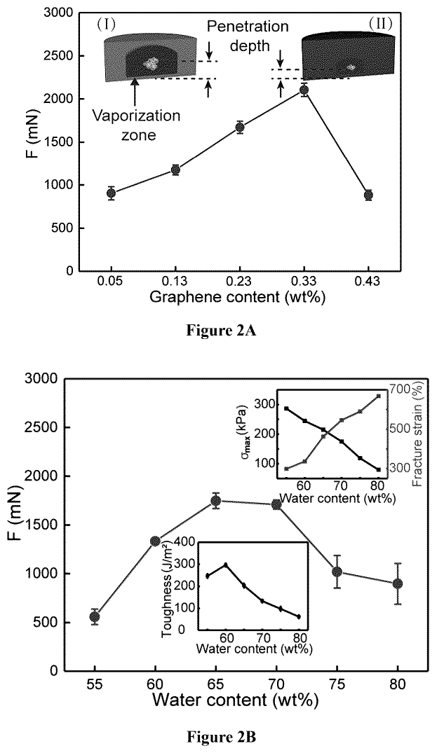

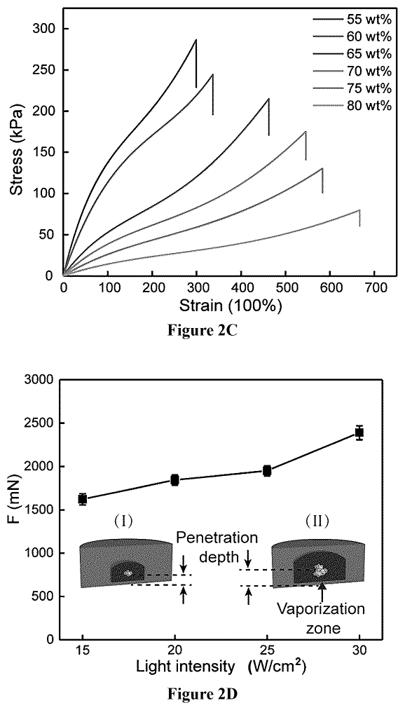

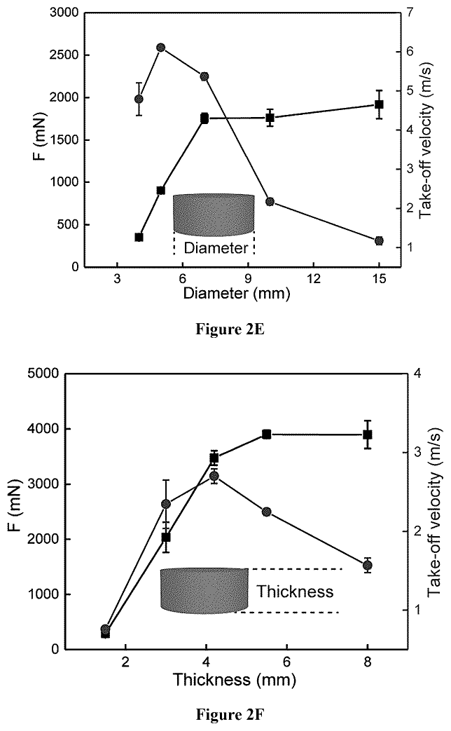

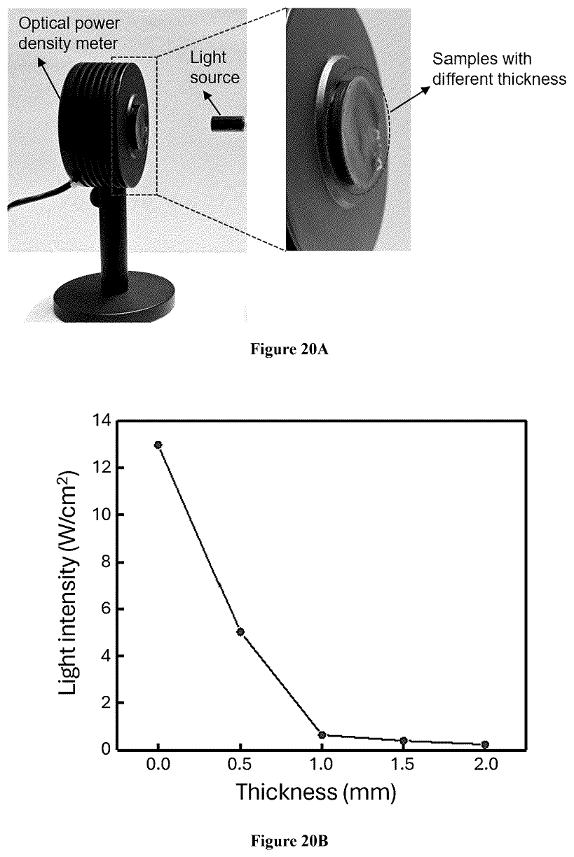

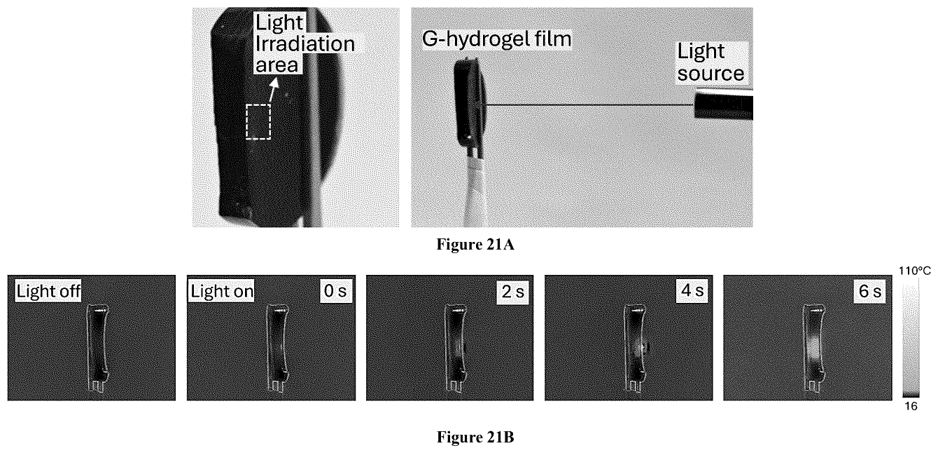

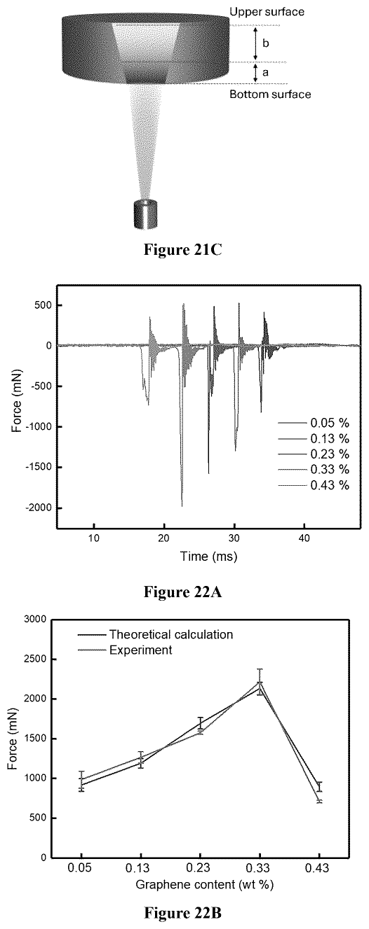

The factors that influence the driving force of G-hydrogel launchers in terms of composition (graphene and water content), light energy input (light intensity), and geometric design (launcher dimensions) was investigated. The driving force is characterized by the vertical motion of the G-hydrogel launcher (find the detailed calculation in Supplementary Note 4). The graphene inclusions function as a photothermal agent that control how heat is converted from the NIR laser stimulation. In this way, the graphene concentration influences water vaporization inside the hydrogel, which in turn controls the force output of G-hydrogel launchers. As shown in FIG. 2A, the driving force increases as the embedded graphene content increases from 0.05 wt % to 0.33 wt % due to the larger thermal power input enabled by the greater graphene concentration, which increases the intensity of the steam expansion and vaporization zone (FIG. 2A-inset I and FIGS. 19A to 19C). However, excess graphene content (0.43 wt %) leads to a reduction in driving force since graphene can block the NIR light and reduce its depth of penetration (FIGS. 20A and 20B). In these cases, it was observed that vaporization occurs very close to the bottom surface of the G-hydrogel launcher (FIGS. 21A to 21C). The shallow depth of vaporization results in a faster rate of fracture for the hydrogel, which reduces the stored elastic energy and results in the reduction of driving force (FIG. 2A-inset II). The results of directly force measurements using the force sensor show similar trends and limited deviation to the calculated results from launching height (FIGS. 22A and 22B). Based on this analysis, it was found that the concentration of the photothermal agent needs to be carefully selected in order to balance the trade-off between the photothermal energy conversion efficiency and the NIR penetration depth.

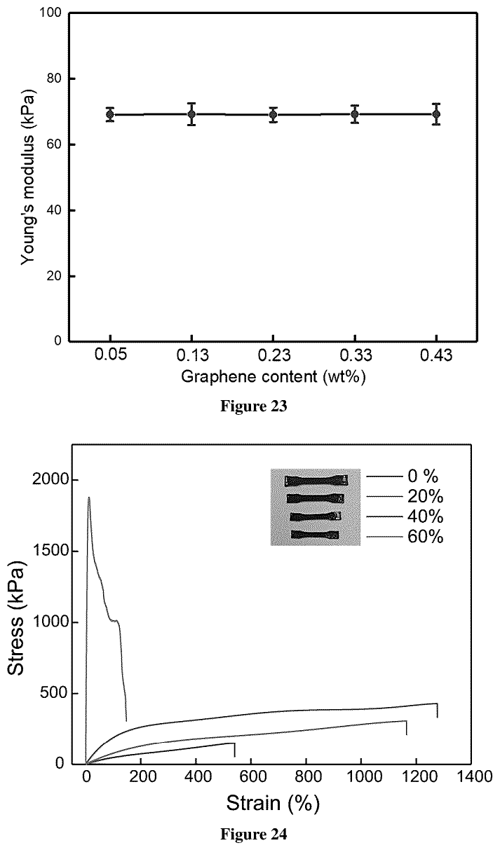

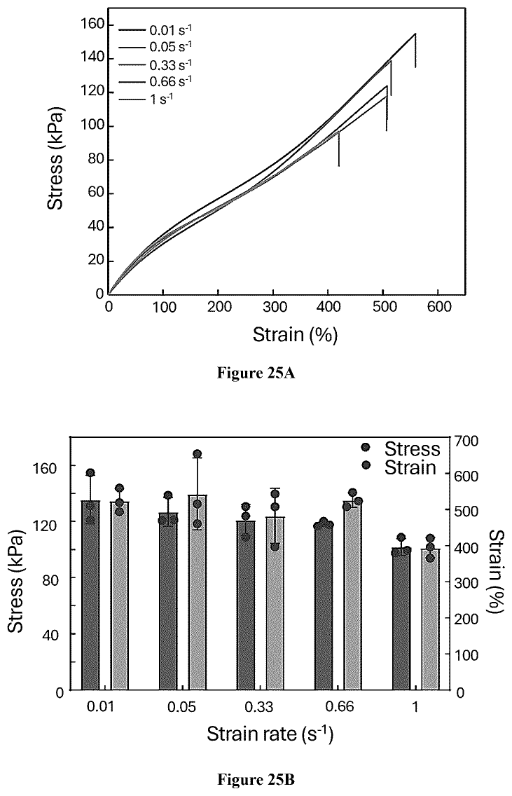

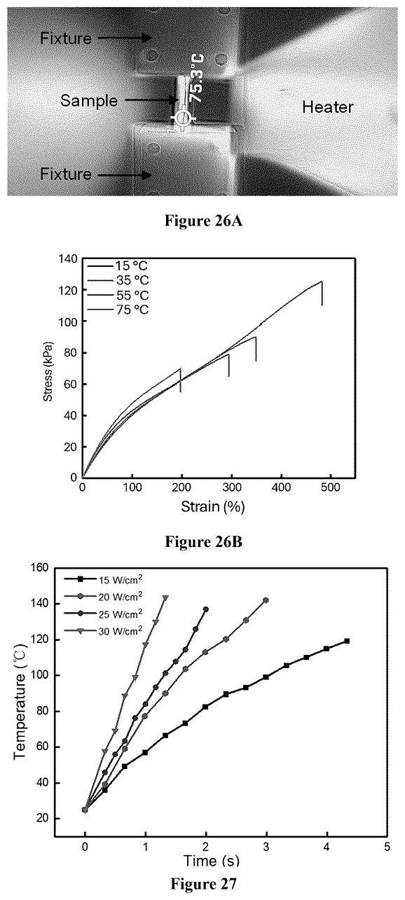

The mechanical analysis in Supplementary Note 2 suggests that the hydrogel materials with a combination of large ultimate strength, high fracture strain, and suitable toughness exhibit greater propulsive motion. The more energy accumulation before fracture, the bigger force output. This is because such materials allow for a larger stored elastic energy (U), which is positively related to the maximum deformation of G-hydrogel launchers (w) and the flexural rigidity (D). In this work, water content was adjusted to tailor the mechanical properties of G-hydrogel, as the small amount of graphene content had a limited influence (FIG. 23). FIG. 2B-inset and the representative stress-strain curves in FIG. 2C show that a higher water content causes the G-hydrogel to have a smaller ultimate strength and larger fracture strain and will also influence the elastic energy storage (find details in Supplementary Note 5). Though different material properties of hydrogel in vaporization zone from original hydrogel, the overall description of actuation process will not be affected obviously as well as the elastic energy estimation due to the small volume of vaporization zone (FIG. 24). These trade-offs in mechanical properties result in an output driving force that is observed to increase and then decrease with the increasing water content. In particular, it was found that the force reaches a peak value at a water concentration of around 65 wt % as shown in FIG. 2B. It should be noted that the results shown in FIG. 2B and can just be used to reveal the relationship between the mechanical property of G-hydrogel materials and the force output of G-hydrogel launchers with different water content because these measurements were conducted at quasi-static strain rate (0.05 s⁻¹) and room temperature, which has large difference from the operational conditions of the G-hydrogel material during actuation (ultrafast strain rate>1000 s⁻¹ and high temperature up to 100° C.). The mechanical behavior of G-hydrogel material under extreme condition was also investigated and found decayed mechanical property, such as the reduced fracture strength and strain (FIGS. 25A, 25B, 26A and 26B).

In addition to material composition, light energy input also has an influence on the launcher driving force. As shown in FIG. 2D and FIG. 27, an increased light intensity means the faster temperature rising, the deeper penetration and larger vaporization zone, which in turn results in a greater driving force. This increase in force originates from larger energy accumulation due to greater deformation of the hydrogel during the process of steam expansion. (FIG. 2D-inset I and II).

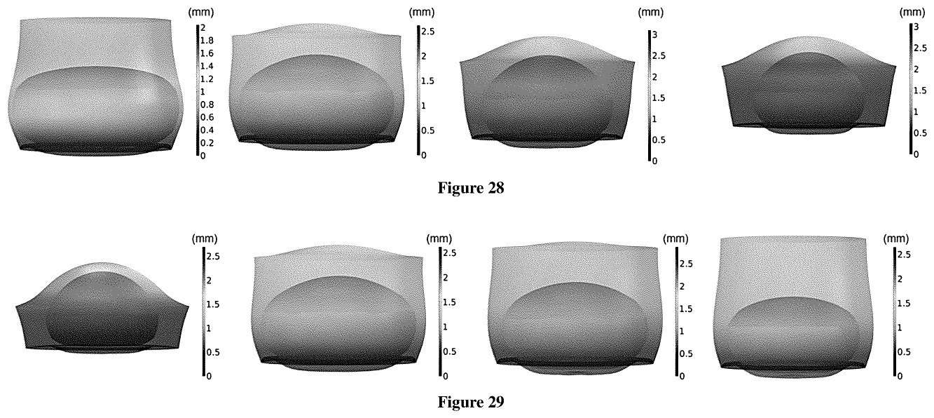

The mechanical analysis in Supplementary Note 2 also suggests that the geometry of the G-hydrogel launcher affects the amount of stored clastic energy, thus, resulting in different driving forces and take-off velocities. The driving force increases with the diameter of the G-hydrogel until it reaches a plateau corresponding to a diameter greater than 7 mm (FIG. 2E). The potential reason for this increase is that the G-hydrogel launcher needs to be large enough compared to the vapor pressured zone to provide sufficient constraint force for clastic energy accumulation. However, continuous increase in diameter (>7 mm) does not lead to a continuous increase in output force due to the limited dimensions of the irradiated zone (spot size of NIR light) (FIG. 2E and FIG. 28). FIG. 2E also shows that the take-off velocity of G-hydrogel launchers first increases and then decrease with increasing diameter. This is due to the increase in the weight of launcher with larger diameter. The effect of the launcher thickness on the driven force and take-off velocity exhibits a similar trend, as presented in FIG. 2F and FIG. 29.

### Motion Control of G-Hydrogel Launchers Based Soft Robots

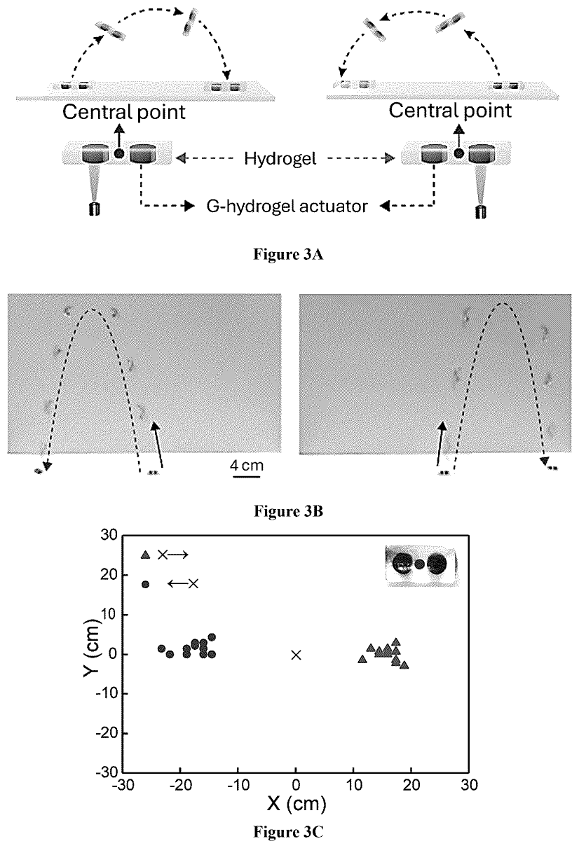

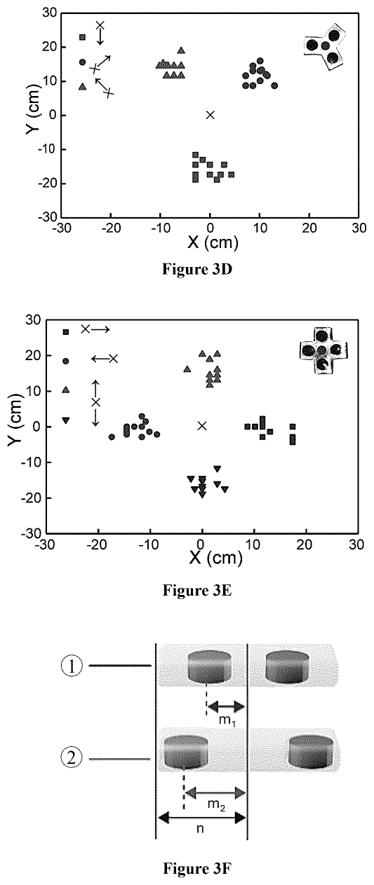

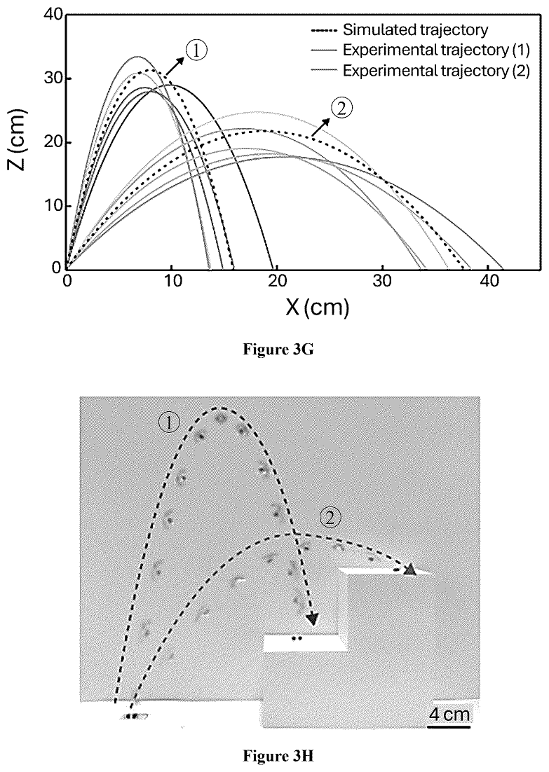

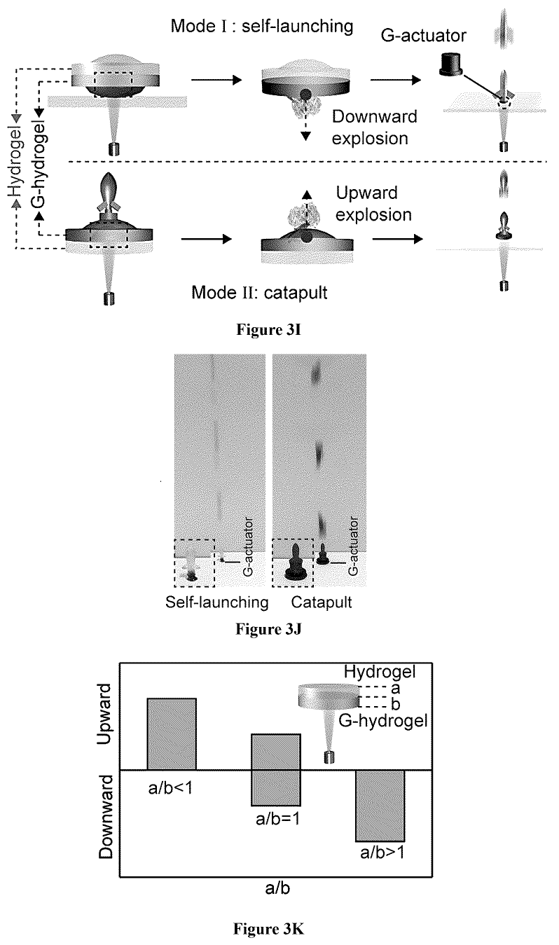

In addition to vertical launching, the ASEF based G-hydrogel launchers can be used to develop hydrogel-based soft robots capable of motion with prescribed trajectories and transportation to prescribed locations. As shown in FIG. 3A, two G-hydrogel launchers are embedded in a pristine hydrogel block. This results in a soft hydrogel robot that can launch in two different directions depending on which launcher is stimulated (FIG. 3B). 12 robots for each direction were launched and recorded their landing locations in FIG. 3C. The results show a consistent landing location, indicating the ability to control the jumping motion. This strategy can be expanded to multidirectional robots, such as the demonstrated hydrogel robots with three and four G-hydrogel launchers shown in Figure D-inset and FIG. 3E-inset, respectively. The recorded landing locations presented in FIG. 3D and FIG. 3E further demonstrate controlled jumping in various directions (Supplementary Video 6).

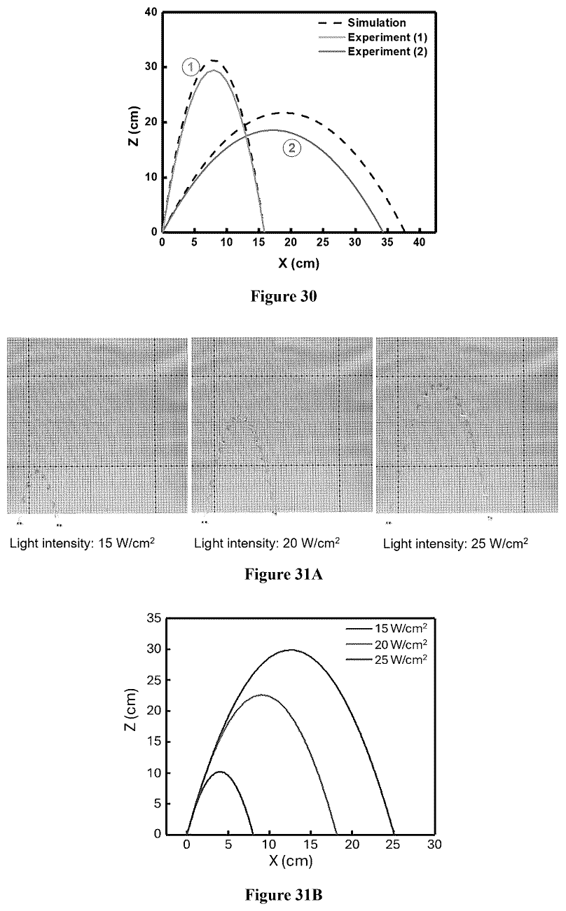

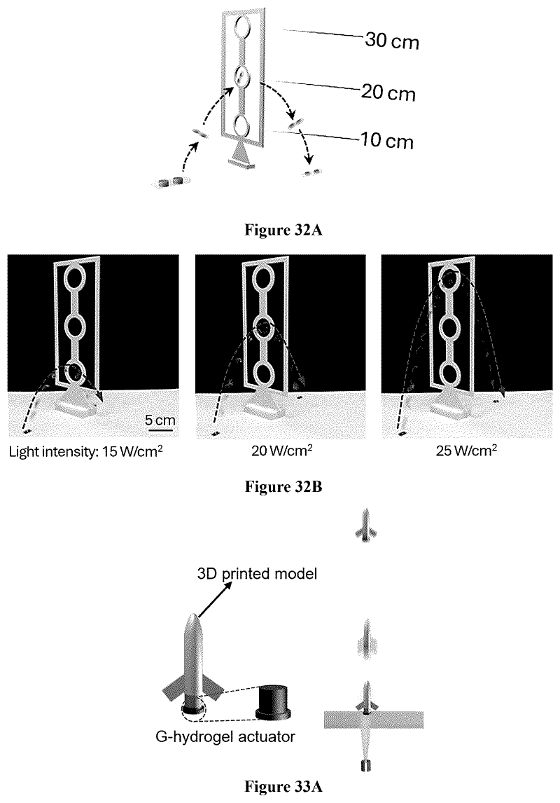

The distance of the G-hydrogel motion can also be prescribed by controlling its launching trajectory. A two-directional hydrogel robot was used to illustrate this design principle. As the schematic presented in FIG. 3F illustrates, two G-hydrogel launchers are incorporated in a passive hydrogel block with a prescribed distance from the centroid plane. The parabola trajectory of the hydrogel robot can be determined by the magnitude and the direction of the take-off velocity as controlled by the impulse generated by the G-hydrogel launcher and their eccentricity (i.e. m/n shown in FIG. 3F)—details of the take-off direction are provided in Supplementary Note 6. Two designs of the hydrogel robot were fabricated to perform the launching experiments and their simulated and experimental trajectories are plotted in FIG. 3G. The trajectories of these ten hydrogel robots (five for each design) cluster within two groups, which exhibit limited deviation from the simulated trajectories shown by the dashed lines in FIG. 3G (simulation details are provided in Supplementary Note 6). This strategy for controlling launching trajectory is visually demonstrated by the launching behaviors of two presentative hydrogel robots shown in FIG. 3H. These two hydrogel robots landed on the corresponding surfaces of the pre-located stair (Supplementary Video 7), whose heights and placement locations were pre-determined based on the corresponding simulated trajectories presented in FIG. 3H and FIG. 30. In addition, the light energy input can also be used to control the launching trajectories due to the different output driving force with different light intensity (FIGS. 31A, 31B, 32A and 32B and Supplementary Video 8).

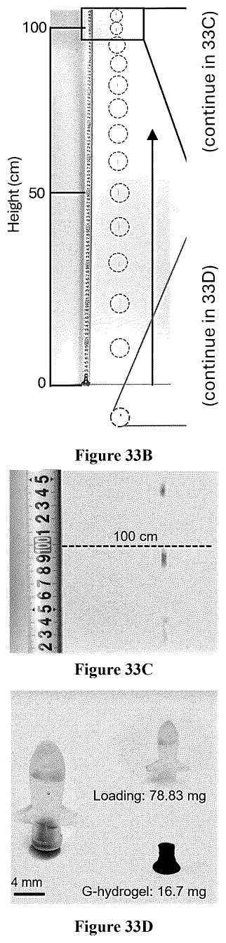

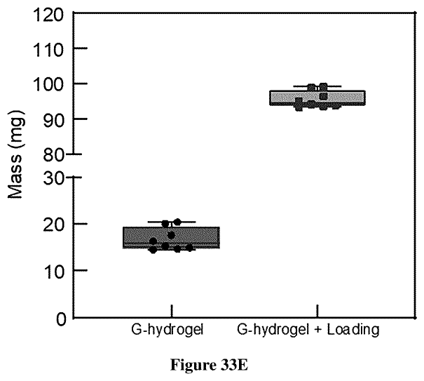

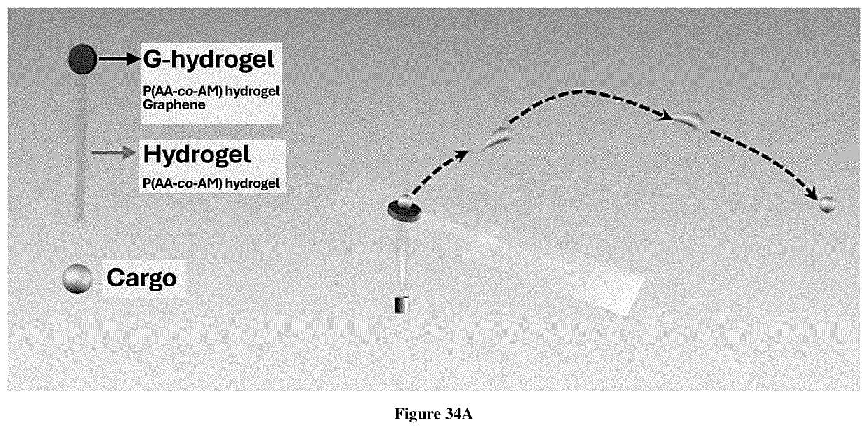

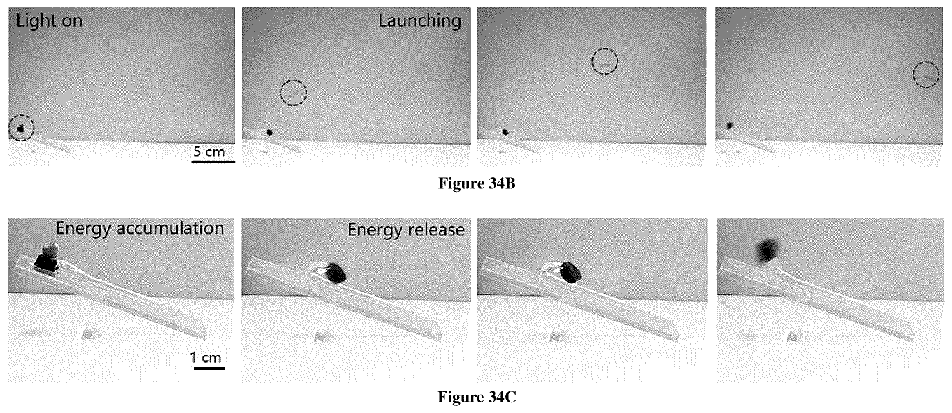

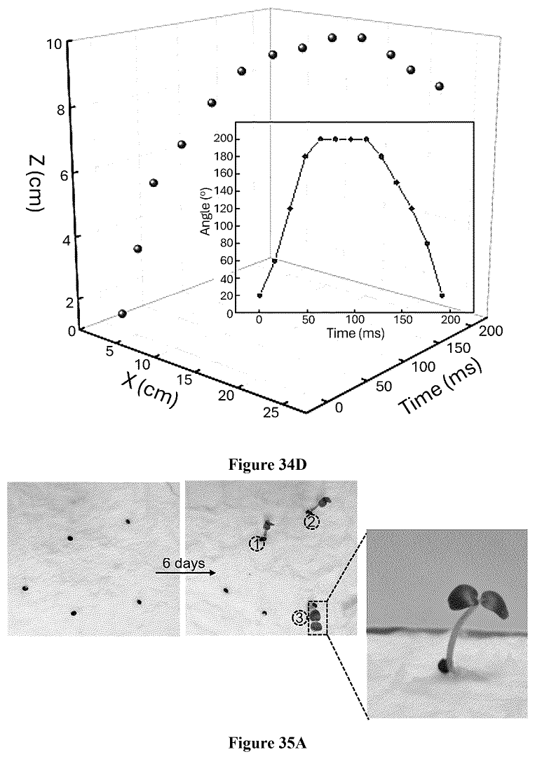

The G-hydrogel launcher can be designed to achieve two different actuation modes (i.e. self-launching and catapult motion) by tailoring the structural composition and geometry to control the location and direction of the ASEF propulsion. As FIG. 3I illustrates, a two-layered structure in which a G-hydrogel layer and a pristine hydrogel layer are stacked together to control the direction of propulsion. The downward and upward jetting of water vapor can be realized, and thus achieve the self-launching and catapult actuation modes, respectively. Two representative use cases are demonstrated by using these two actuation modes to achieve a mini rocket (self-launching mode) and a catapulting pad to launch a mini rocket projectile (catapult mode) with high-speed motion (FIG. 3J, FIGS. 33A to 33E and 34A to 34D and Supplementary Video 9). Note that in order to ensure the controllability of the motion, the thickness of the constrained layer (pristine hydrogel) should be larger than the thickness of the hydrogel layer dopped with graphene (G-hydrogel) (FIG. 3K).

### Bio-Mimic Seed Dispersal of Ecballium Elaterium and Smart Seeding Robot

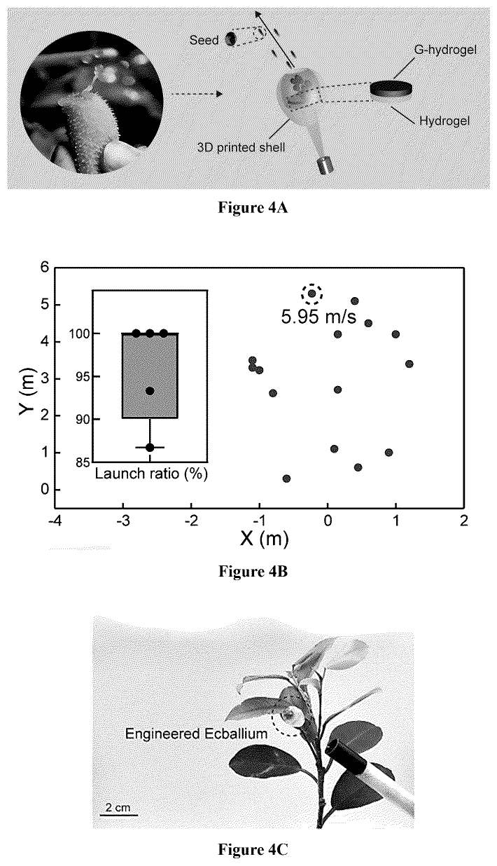

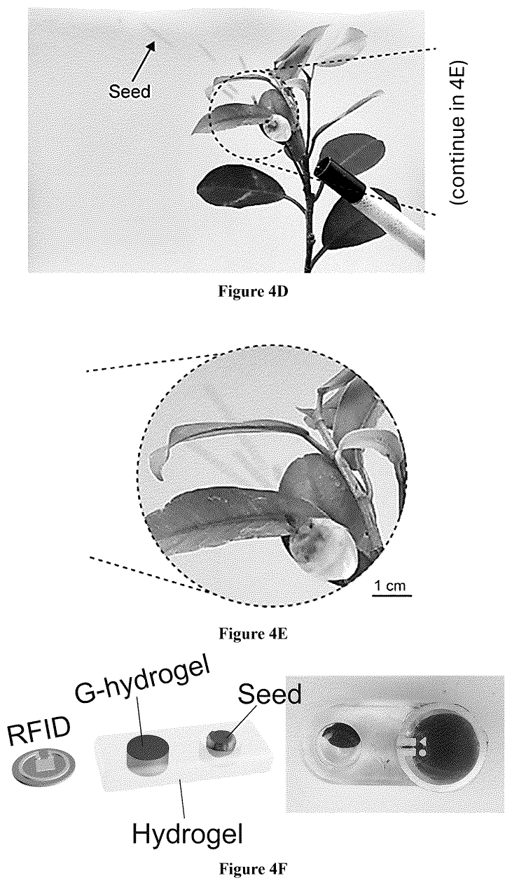

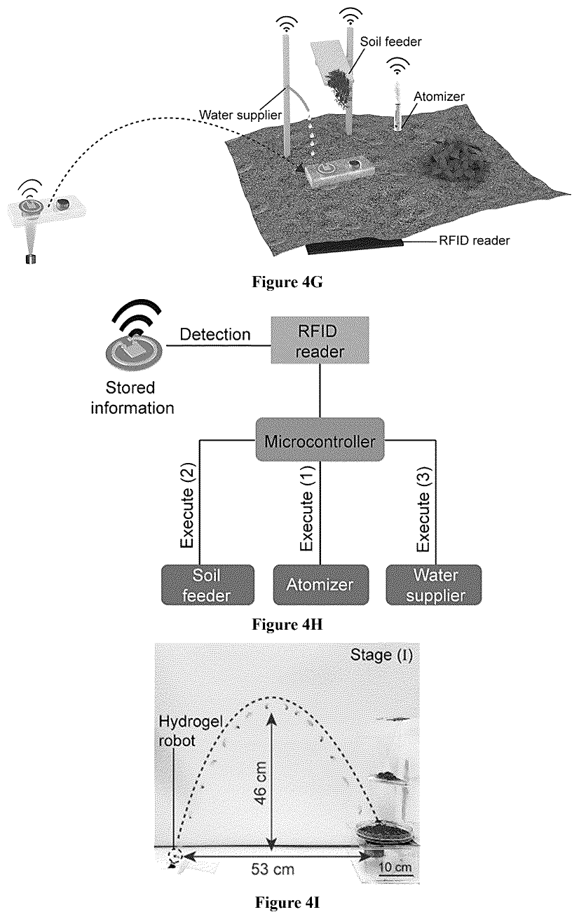

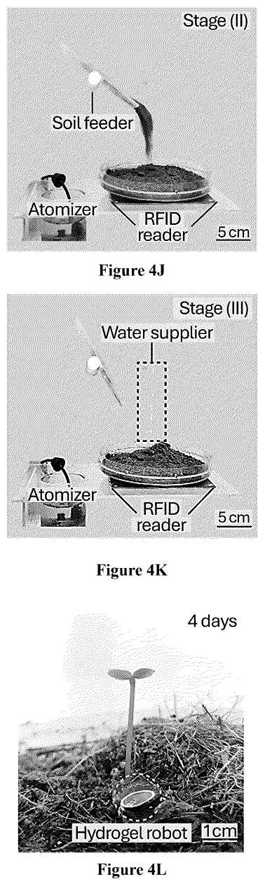

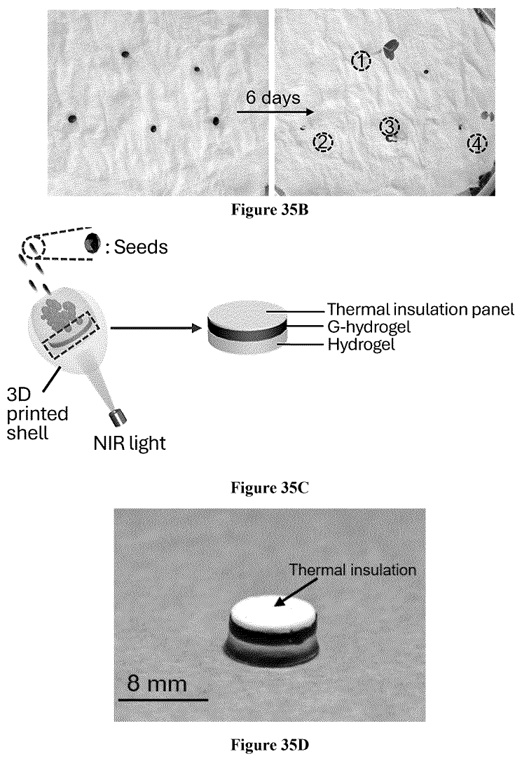

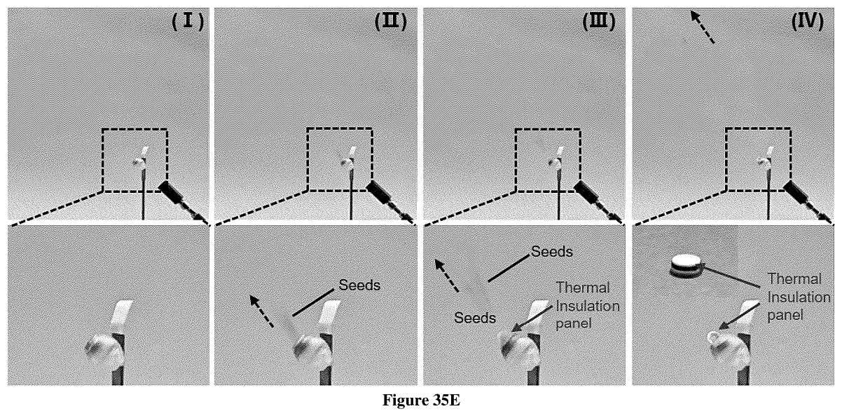

To demonstrate the potential robotic applications of this ASEF based G-hydrogel launcher, an engineered version of the Ecballium elaterium was first built to mimic the process of seed dispersal (FIG. 4A). As the schematic shown in FIG. 4A, the G-hydrogel launcher was fabricated and assembled inside a 3D printed semi-transparent resin shell, which was placed on the branch of a plant. Fifteen black glass beads were inserted on the top of the G-hydrogel launcher to mimic seeds. This artificial Ecballium elaterium ejected the glass beads at high speeds through NIR stimulation (Supplementary Video 10). The landing locations of these glass beads were recorded to analyze the actuation performance of engineered Ecballium elaterium. As shown in FIG. 4B, a greater than 96% success rate of beads launching for five actuation experiments was demonstrated. Representative statistics of the landing locations show a maximum launch displacement of 5.3 m, corresponding to the take-off velocity of 5.95 m/s (detailed calculations in Supplementary Note 7). This bio-mimetic high speed seed dispersal suggests that the G-hydrogel launcher can match the force and acceleration of natural power-amplification mechanisms (FIGS. 4C to 4E). Moreover, the exposure to high-temperature vapor for an ultra-short time period does not affect the germination rate of real seeds (FIGS. 35A and 35B). This bioinspired seed disposal device can be further improved by adding a thermal insulation panel between the seeds and G-hydrogel launcher to avoid the effects of high-temperature vapor altogether without affecting the performance of the projection (FIGS. 35C to 35E).

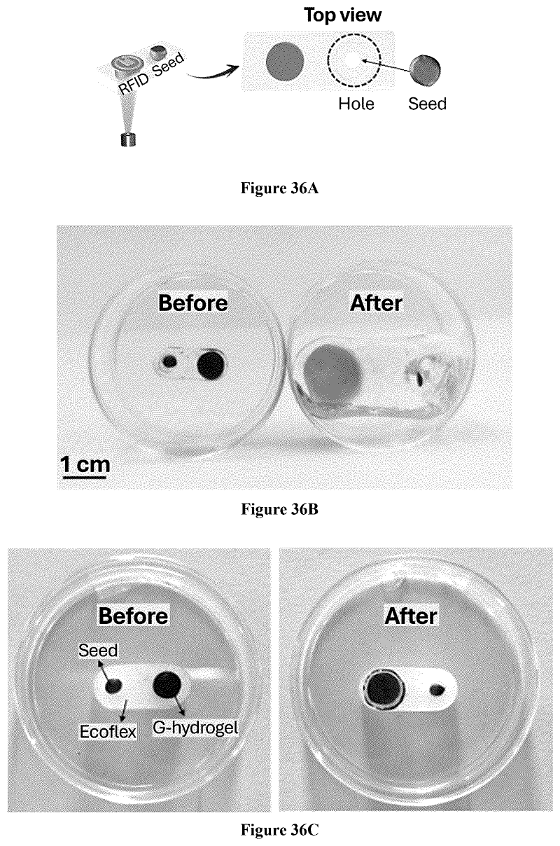

The high instantaneous driving force and the predictable trajectory of locomotion make this ASEF based G-hydrogel launcher potentially useful for applications in soft robotics. One use case in which the launchers are used for a hydrogel based smart seed robot for automatically planting seeds within a soil was demonstrated. As illustrated in FIGS. 4F and 4G, the soft hydrogel robot consists of a G-hydrogel launcher, a plant seed placed inside of the hydrogel body, and an integrated radio-frequency identification (RFID) tag. The hydrogel robot was actuated by a NIR laser, causing it to jump into a smart, sensorized planting bed (FIGS. 4H and 41). The smart bed contains an RFID reader, a cultivation soil bed, an automatic soil feeder, an automatic water supplier, and a humidifier. When the hydrogel robot lands on the soil bed, the underlying RFID reader reads out the seed cultivating information from the RFID tag and then broadcasts to a control hub to execute corresponding operations, such as the supply of water and fresh soil (FIGS. 4J and 4K). After water is supplied, the hydrogel robot can absorb the water and swells up to release the seed, which gets planted in the soil (FIGS. 36A to 36C). Finally, the planted seed successfully sprouts, indicating the ability of the soft robot to performing a planting task through wireless, NIR-based activation (FIG. 4L and Supplementary Video 11).

This work presents a power-amplification method that is light driven and harnesses the synergetic interactions between the elasticity of a copolymerized hydrogel network and water vaporization caused by the photothermal response of embedded graphene. This soft hydrogel launcher is capable of ASEF propulsion, with controllable catapulting and self-launching motion behaviors that are characterized by an exceptionally high take-off acceleration (2.5×10⁴ m/s²; >2500 g), launching height (643 BL, >1.93 m) and ultra-short energy releasing time (0.3 ms). The key principle of material architecture design is to select a matrix that combines high toughness, high elasticity, and doped with a photo-responsive filler to realize rapid vaporization transition (Supplementary Note 8). In addition to selected G-hydrogel material system, potential candidates for material selection were also listed in Supplementary Table 2. It is envisioned that these material design principles will provide further insight into the power amplification mechanism and stimulate new design in domains that require rapid motion, jumping, or launching of objects over prescribed distances.

What is claimed is:

1. A light response material, comprising:
a. A hydrogel of sufficient fracture toughness to accumulate elastic energy for actuation prior to fracture; and
b. A photothermal material dispersed in said hydrogel capable of initiating phase transition of water inside said hydrogel from liquid to vapor when irradiated with light to cause accumulation of said elastic energy.

2. The light response material of claim 1, wherein said hydrogel is a copolymer hydrogel.

3. The light response material of claim 2, wherein said copolymer hydrogel is covalently cross-linked.

4. The light response material of claim 2, wherein said copolymer hydrogel comprises two or more polymers selected from the group consisting of acrylic acid (AA), Acrylamide (AAm), Sodium Acrylate, and Vinylpyrrolidone (VP).

5. The light response material of claim 1, wherein said photothermal material comprises one or more selected from the group consisting of graphene, carbon nanotubes (CNTs), polypyrrole nanoparticle, and Fe₃O₄ nano particles.

6. The light response material of claim 1, wherein said photothermal material is present in an amount of 0.05 wt % to 0.43 wt %.

7. The light response material of claim 1, wherein said hydrogel has a water content of 55 wt % to 80 wt %.

8. The light response material of claim 1, wherein said light comprises NIR laser.

9. A launcher comprising the light response material of claim 1.

10. The launcher of claim 9, wherein said light response material has a thickness of 3 to 6 mm.

11. The launcher of claim 9, wherein said light response material has a diameter of 3 to 15 mm.

12. A robot comprising the light response material of claim 1.

13. The robot of claim 12, comprising two or more of said light response material being embedded in a block to be actuated.

14. The robot of claim 12, comprising a layer of said light response material attached to a layer of constrain material.

15. The robot of claim 12, further comprising a RFID tag containing information to be read out by a RFID reader.

16. A system comprising:
a. the robot of claim 15;
b. a light source for initiating actuation of said robot; and
c. a RFID reader for reading said information from the RFID tag.

17. The system of claim 16, further comprises a communication module for conveying said information to other components.

18. A method to fabricate the light response material of claim 1, comprising the steps of:
a. Providing a solution comprising a precursor of said hydrogel and said photothermal material; and
b. Irradiating said solution with UV light.

19. The method of claim 18, wherein said hydrogel is a copolymer hydrogel comprising two or more polymers selected from the group consisting of acrylic acid (AA), Acrylamide (AAm), Sodium Acrylate, and Vinylpyrrolidone (VP).

20. The method of claim 18, wherein said photothermal material comprises one or more selected from the group consisting of graphene, carbon nanotubes (CNTs), polypyrrole nanoparticle, and Fe₃O₄ nano particles.
